(19) United States
(12) Patent Application Publication
(10) Pub. No.: US 2023/0363528 A1
(43) Pub. Date: Nov. 16, 2023

(54) Monitor Riser

(71) Applicant: Akhmad Fauzan, Singapore (SG)

(72) Inventor: Akhmad Fauzan, Singapore (SG)

(21) Appl. No.: 17/744,681

(22) Filed: May 15, 2022

(51) Int. Cl. A47B 21/00; A47B 13/12

(52) U.S. Cl. CPC A47B 21/00; A47B 13/12; A47B 2220/0077

(57) ABSTRACT

A novel form of assembly is disclosed aimed at providing monitor riser with multiple LED lights and are controlled by an associated application. The monitor riser can be used for working and gaming and provides associated application which is able to control the light patterns, lights intensity, synchronization with music or sound or give reminders to the user by playing a curtain light pattern.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

The present invention relates in general to a Monitor riser, and more particularly, to an LCD monitor riser having RGB lights controlled by an associated application.

### Description of the Related Art

In the era of global technology advances, advanced and sophisticated electronic and electrical products have been continuously created. A television or computer uses a display monitor for video output. For the disadvantages of large size, poor picture quality and being incapable of receiving digital signals, the old CRT type display monitor has been gradually out of the market and replaced by a LCD or plasma type display monitor that has the advantages of having light and thin characteristics, good picture quality and being capable of receiving analog and digital signals. Some people directly affix a display monitor to an upright wall using a display monitor rack, or purchase a monitor stand to support the structure in an upright position.

There are many inventions that have been found in prior art regarding aiding in providing advancements in similar field. For instance, a U.S. Pat. No. 9,207,722B2 discusses tablet and monitor support systems. The support systems and related methods for supporting tablets and monitors. A stand that includes a monitor support portion configured to support a monitor and a tablet support portion configured to support a tablet.

A U.S. Pat. No. 9,163,779B2 discusses tablet mounting systems, stands, and methods. Embodiments of a tablet mounting system include a detachable tablet stand and a tablet mount. The tablet stand is configured to releasably retain a tablet and to rest on a horizontal surface such that a plane defined by the tablet stand forms an angle with the horizontal surface. The formed angle is equal to or greater than zero, and less than or equal to ninety degrees. The tablet mount is configured to attach to a support member. The tablet mount is configured to releasably retain the tablet stand and the tablet retained within the tablet stand. The tablet stand can be configured to releasably retain a tablet by compression against a length of the tablet or by compression against a thickness of the tablet. The tablet mount can include a docking station that has a connector configured to connect with a port on a tablet.

A U.S. Pat. No. 10,066,785B1 on a display screen support device includes a base unit providing an upright shaft and a stop member at the upright shaft, a first support arm including a first pivot-connection device coupled to the upright shaft and supported on the stop member and a first extension device transversely extended from the first pivot-connection device for supporting a display screen, and a second support arm including a second pivot-connection device coupled to the first pivot-connection device and a second extension device transversely extended from the second pivot-connection for supporting another display screen. The second pivot-connection device of the second support arm relative can be biased relative to the first pivot-connection device of the first support arm within a limited angle for allowing adjustment of the relative angular position between the two supported display screens.

A U.S. Pat. No. 7,559,520B2 on apparatuses and methods for supporting peripheral devices is an apparatus for supporting a peripheral device includes a yoke that is adapted to attach to a rear of a display, the yoke including at least one arm that is adapted to extend to a side of the display so that an end of the at least one arm is positioned adjacent a side edge of the display, the end including a peripheral device mounting element.

A U.S. Pat. No. 7,014,154B2 on LCD monitor stand discusses an LCD monitor stand includes a base part, a stand part to stand on the base part and having a cable accommodating part to accommodate cables therein, a hinge shaft positioned across a standing direction of the stand part, a first rotation member to rotate up and down on the hinge shaft, and a second rotation member rotatably coupled to the first rotation member, to rotate the LCD monitor in a planar direction. With this configuration, it is possible to apply tilting and pivoting structures to the internal cable type LCD monitor.

There are multiple patents that have been found in prior art regarding utilization of Baobab fruit in multiple forms. However, their utility in everyday life isn't seen extensively. The current invention proposes a unique form of monitor riser which in addition to its original functionality provides a combination of RGB lights which improve the user experience of using a monitor riser. The disclosed assembly is coupled with an associated application where the light is beamed from the back edge of the glass table so that it would be dispersed by the glass medium and shine the other 3 edges of the glass table.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to a monitor riser with set of multiple LED lights to enhance the functionality and experience of user.

It is further the objective of the invention to provide an assembly which has a structure designed to provide the luxury of utility and design in a single assembly.

It is also the objective of the invention to provide a monitor riser which is coupled with an associated application and can control the LED lights.

It is furthermore the objective of the invention to provide user with aesthetic satisfaction by the beautiful and light weight design of the current assembly.

It is further the objective of the invention to provide a monitor stand of high quality which can be used over longer period of time without comprising on its functionality.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the front view of assembly as per preferred embodiments of the invention.

FIG. 2 shows the left view of assembly as per preferred embodiments of the invention.

FIG. 3 shows the right view of assembly as per preferred embodiments of the invention.

FIG. 4 shows the back view of assembly as per preferred embodiments of the invention.

FIG. 5 shows the top view of assembly as per preferred embodiments of the invention.

FIG. 6 shows the bottom view of assembly as per preferred embodiments of the invention.

FIG. 7 shows the exploded view of assembly as per preferred embodiments of the invention.

FIG. 8 shows the front view of assembly as per preferred embodiments of the invention.

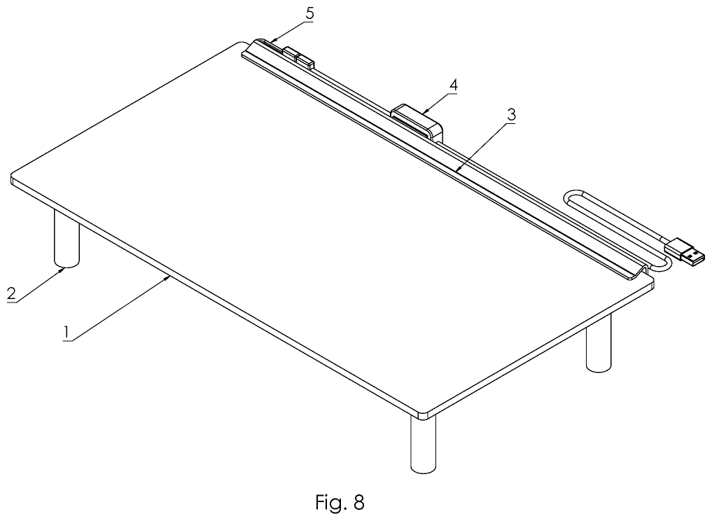

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses housing of monitor riser which provides LED light and a connected application to control the lights. The application is able to control the light to have patterns, synchronized with music or sound, or give reminders to the user by playing a curtain light pattern.

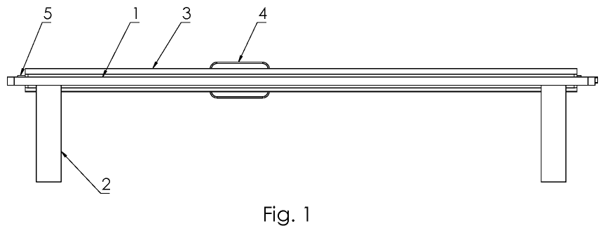

The attached drawings are showing multiple views and details of assembly. The FIG. 1 shows front view of assembly where the transparent glass (1), LED holder (3) can be seen at the top surface of the monitor riser. The Legs (2) are four in number to support the assembly and are foldable in nature. The LED controller (4) can also be seen in FIG. 1.

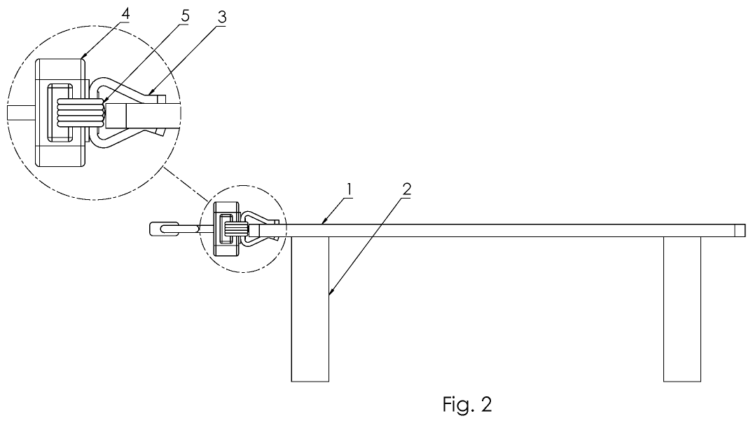

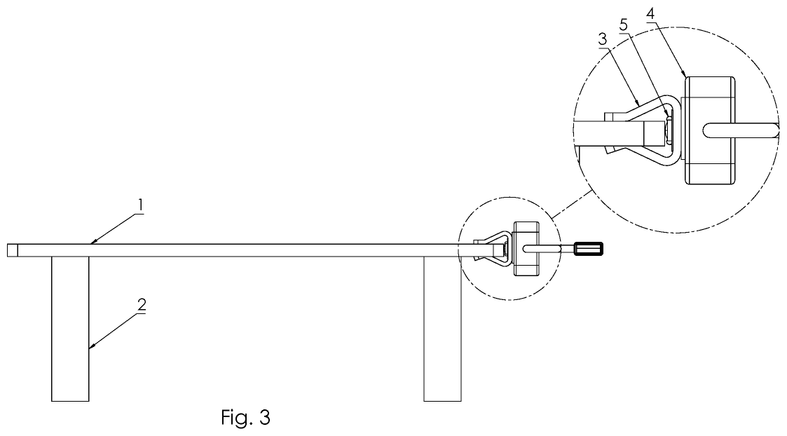

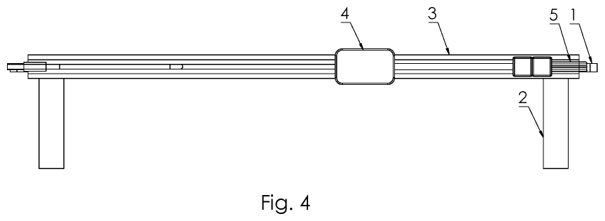

The FIG. 2 and FIG. 3 are showing the left and right view of assembly where transparent glass (1), LED holder (3), Leg (2), LED strip (5) and LED controller can be seen. The FIG. 4 shows the back view of assembly where back configuration of monitor riser and its LED panel can be seen in detail.

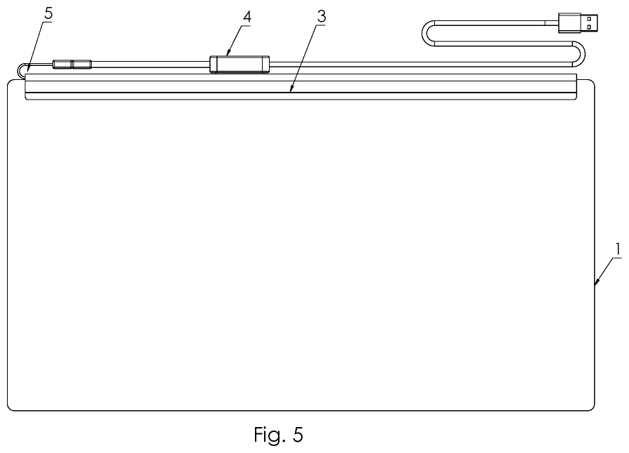

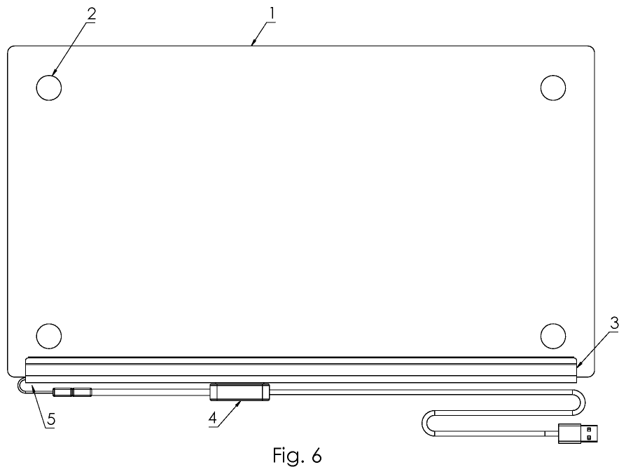

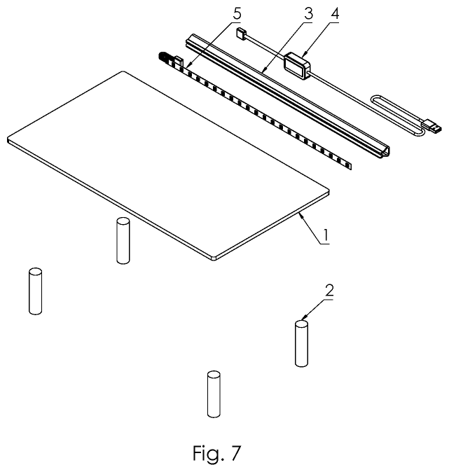

The FIG. 5 and FIG. 6 are showing the top and bottom view respectively. The FIG. 7 is showing the exploded view where Transparent Glass (1), Led Holder (3), Leg (2), Led Strip (5) and Led Controller (4) can be seen in detail.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret, or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A monitor riser assembly with LED lights and associated application comprising:
Transparent Glass (1);
Legs (2);
LED Holder (3);
LED Strip (5); and
LED Controller (4)
the assembly as per claim 1, is aimed to provide its traditional functionality of rising the assembly for comfortable view and usage;
the assembly as per claim 1, has LED lights;
the assembly as per claim 1, has associated application to control the lights.

2. The light is beamed from the back edge of the glass table and will be dispersed by the glass medium and will shine the other three edges of the glass table.

3. The LED controller connects the light to the associated application to perform further actions including but not limited to control the intensity of lights, colors of lights and synchronization of music with lights.
